(19) United States
(12) Patent Application Publication
(10) Pub. No.: US 2007/0029298 A1
(43) Pub. Date: Feb. 8, 2007

(54) Temperature sensor and heating system using same

(75) Inventors: Kazunori Takagi, Kanazawa-shi (JP); Toru Nakada, Kanazawa-shi (JP); Shigeru Sugita, Kanazawa-shi (JP)

Correspondence Address: BROWDY AND NEIMARK, P.L.L.C.;624 NINTH STREET, NW, SUITE 300, WASHINGTON, DC, 20001-5303, US

(73) Assignee: JBH CO. LTD., Kanazawa-shi (JP)

(21) Appl. No.: 11/412,139

(22) Filed: Apr. 27, 2006

(30) Foreign Application Priority Data
Aug. 2, 2005 (JP) 2005-224076

(51) Int. Cl. H05B 3/00

(52) U.S. Cl. 219/200

(57) ABSTRACT

A temperature sensor of a simple construction using PTC devices which efficiently detects a temperature in a wide area of a planar heater is realized. The temperature sensor has excellent durability, manufacturability and installability and can be manufactured at reduced cost. For this purpose, the temperature sensor comprises a plurality of temperature detection chips formed flat, each using a PTC device, enclosed by a pressure resisting member, and connected in series by a temperature detection signal cable. The temperature sensor is further laminated between layers of an insulating film and, as a whole, formed like a ribbon.

### BACKGROUND OF THE INVENTION

1. Field of the Invention

The present invention relates to a temperature sensor for detecting a temperature change in a planar heater used for floor heating and various other heating and also to a heating system using the temperature sensor.

2. Description of the Related Art

Various planar heaters for electric floor heating systems are known. One such conventional example has a cord heater arranged in zigzag on a predetermined size of plane (e.g., Patent Document 1). Another conventional example has a heating material made mainly of carbon printed in a predetermined width and thickness, at predetermined intervals and in strips or bands on an insulating film sheet such as PET (polyethylene terephthalate) (e.g., Patent Document 2).

The floor heating systems of this kind uses an overheat prevention device or excess temperature rise prevention device (e.g., Patent Document 1) that employs a bimetallic thermostat, thermofuse or a device taking advantage of PTC (Positive Temperature Coefficient) characteristic to prevent a heater from getting overheated and which stops supplying electricity to the heater when overheated.

In a floor heating system of recent years, a performance improvement of the planar heater enables the entire planar heater to heat up and keep a desired temperature. The temperature management therefore need only be performed at one part of the planar heater and the overheat prevention device be installed at only a part of the planar heater. However, if the user uses the floor heating system wrongly, as when an object is placed on that part of the planar heater which is not temperature-monitored and an partial external pressure is applied to that portion, heat is trapped there causing the temperature to rise abnormally high. Considering such a case, it is desired that a wide area of the planar heater be monitored for temperature change. However, if such a temperature management is performed using a conventional thermostat, the following problems arise. While it has a self-resetting characteristic and is highly reliable, the thermostat makes the structure of the floor heating system complex because a large number of them needs to be used in a wide area of the planar heater, making the manufacture and installation of the system difficult and costly. The thermofuse on the other hand has the following drawback. Since it has no self-resetting characteristic, once electric supply to the heater is stopped, it requires maintenance. That is, it is not convenient to use and not practical. As for the overheat prevention device using a device having a PTC characteristic, it is simpler in construction and less costly than the device using the thermostat. It has, however, a disadvantage that since a strong heating current is repetitively applied to the PTC device, the PTC device easily deteriorates making it difficult to maintain the PTC characteristic for a long period of time.

The present invention has been accomplished to solve the above problems and is intended to provide an easy-to-use temperature sensor and a heating system using it which adopts a system of controlling the on-off operation of the planar heater based on the detection of temperature in wide area of the planar heater, which has a simple construction using a device having a PTC characteristic and can detect a temperature efficiently over a wide range of planar heater, and which has excellent durability, manufacturability and installability and can also reduce cost.

### SUMMARY OF THE INVENTION

To achieve the above objective, the temperature sensor of this invention comprises: a plurality of temperature detection chips each formed flat and made of a device having a PTC (Positive Temperature Coefficient) characteristic, the temperature detection chips being adapted to detect a temperature change to turn on or off a current application; pressure resisting members enclosing the individual temperature detection chips to protect them from external pressure; and a temperature detection signal cable made of a flexible conductor, the flexible conductor being able to be extended or bent in a desired direction for wiring to connect the temperature detection chips in series; wherein the temperature detection chips are located at arbitrary scattered positions on a planar heater and a signal current is applied to the temperature detection signal cable to detect a temperature change in the planar heater. It is preferred that the plurality of temperature detection chips be protected by pressure resisting members, laminated between layers of an insulating film along with the temperature detection signal cable and, as a whole, formed like a ribbon. It is also preferred that the temperature sensor further include a means to control a current application to the temperature detection signal cable, the means being independent of a means for controlling the planar heater.

The heating system of this invention employing a variety of planar heaters has the above-described temperature sensor.

The temperature sensor of this invention has the above simple construction using PTC devices and is able to efficiently detect a temperature in a wide area of the planar heater. The temperature sensor has many advantages, including excellent durability, manufacturability, installability and reduced cost. Based on the temperature detection by the temperature sensor in a wide area of the planar heater, the energization of the planar heater is controlled to secure safety. That is, should an excess temperature rise occur in one of planar heaters as a result of a wrong use of a heating system on the part of the user, the temperature sensor of this invention can reliably stop current application to the planar heater.

The heating system of this invention has the above simple construction using PTC devices and is able to efficiently detect a temperature in a wide area of the planar heater. The heating system has many advantages, including excellent durability, manufacturability, installability and reduced cost. Based on the temperature detection by the temperature sensor in a wide area of the planar heater, the energization of the planar heater is controlled to secure safety. That is, should an excess temperature rise occur in one of planar heaters as a result of a wrong use of a heating system on the part of the user, the temperature sensor of this invention can reliably stop current application to the planar heater.

The above objects and advantages of this invention will become more apparent from the following detailed description when taken in conjunction with the illustrative embodiments in the accompanying drawings.

### BRIEF DESCRIPTION OF THE DRAWINGS

FIG. 1 is a side cross-sectional view of a temperature sensor in a first embodiment of this invention.

FIG. 2 is an exploded, side cross-sectional view of the temperature sensor of the embodiment.

FIG. 3 is a plan, cross-sectional view of the temperature sensor of the embodiment.

FIG. 4 is a perspective view of a floor heating system using the sensor of the embodiment.

FIG. 5 is a side cross-sectional view of a temperature sensor in a second embodiment of this invention.

FIG. 6 is a plan, cross-sectional view of the temperature sensor of the second embodiment.

FIG. 7 is a schematic plan view of a temperature sensor in a third embodiment of this invention.

FIG. 8 is a partially enlarged, cross-sectional view showing an example connection between a temperature detection chip of the temperature sensor and a temperature detection signal cable in the third embodiment.

FIG. 9 is a partially enlarged, cross-sectional view showing another example connection between a temperature detection chip of the temperature sensor and a temperature detection signal cable in the third embodiment.

FIG. 10 is a schematic plan view showing a modified example of a temperature sensor of the third embodiment.

FIG. 11 is a side cross-sectional view showing a pressure resisting member for the temperature detection chip of the temperature sensor of the third embodiment.

### DESCRIPTION OF THE PREFERRED EMBODIMENTS

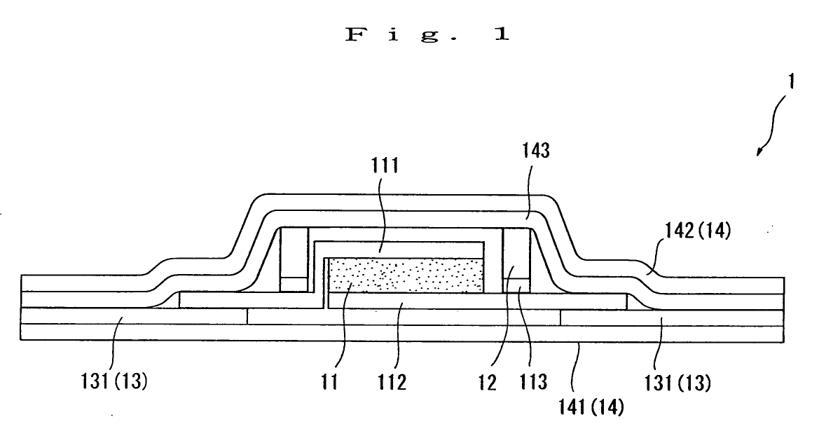

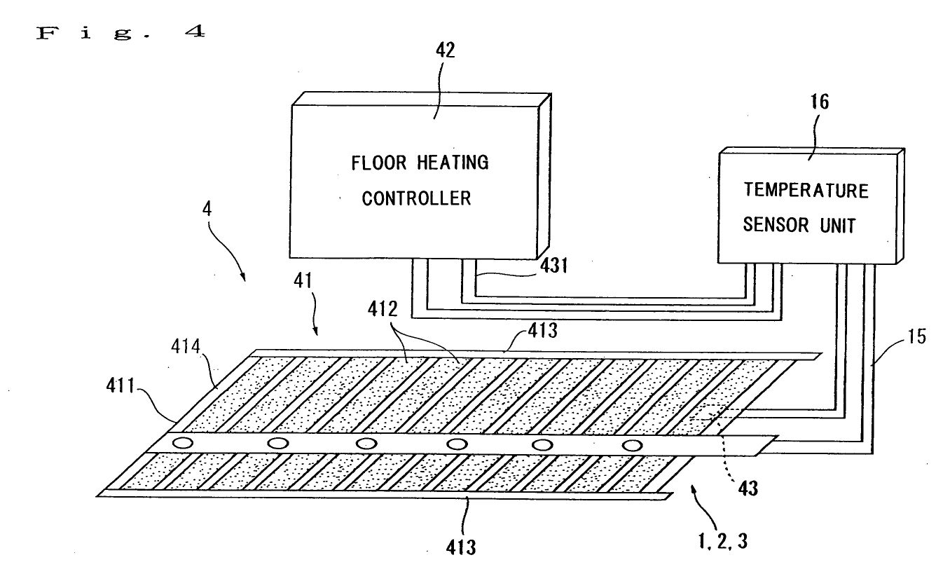

Now, embodiments of this invention will be described by referring to the accompanying drawings. FIG. 1 to FIG. 3 illustrate a temperature sensor according to a first embodiment of this invention. In FIG. 1, the temperature sensor 1 has a plurality of temperature detection chips 11, pressure resisting members 12 to protect the temperature detection chips 11, a temperature detection signal cable 13 to connect these temperature detection chips 11 in series, and a temperature sensor unit 16 (see FIG. 4) to control the temperature sensor 1.

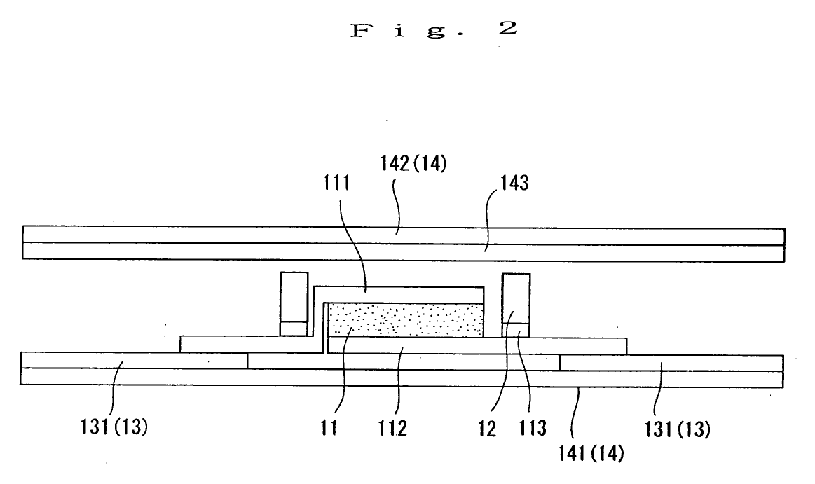

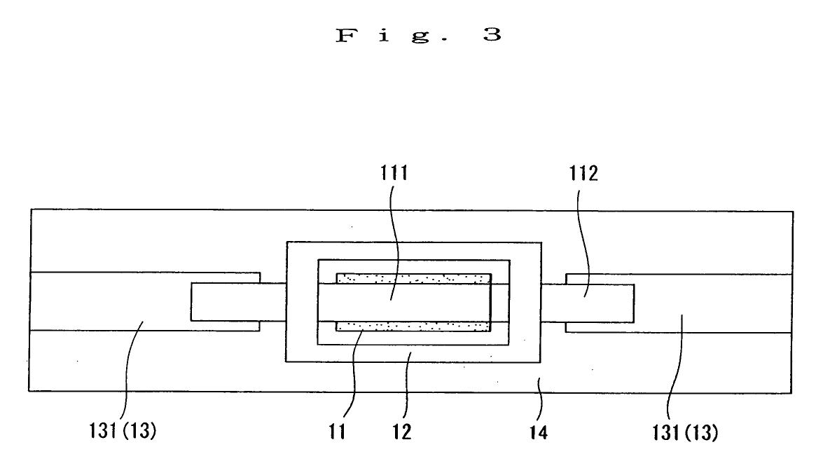

As shown in FIG. 2 and FIG. 3, each of the temperature detection chips 11 is formed of a device having a PTC (Positive Temperature Coefficient) characteristic (simply referred to as a PTC device) and shaped rectangular or circular, with its upper and lower surfaces attached with lead terminals 111, 112. The upper lead terminal 111 is bent from the top surface of the temperature detection chip 11 toward end face of the chip on one side, with its lower end bent again and drawn outward. The lower lead terminal 112 is drawn outward from the other end face of the temperature detection chip 11. The temperature-detection chip 11 has a function of turning on or off an electric supply according a temperature change detected by the PTC characteristic, in which an electric resistance sharply changes with a temperature rise.

The pressure resisting member 12 of each temperature detection chip 11 is a spacer, rectangular in plan view, enclosing the temperature detection chip 11. The pressure resisting member 12 is formed of PET, with its inner periphery set slightly larger than an outer periphery of the temperature detection chip 11 and its height set slightly larger than that of the chip 11. The pressure resisting member 12 encloses the temperature detection chip 11 and is securely fixed with an adhesive 113 to the lead terminals 111, 112, thus protecting the temperature detection chip 11 from an external pressure.

The temperature detection signal cable 13 that connects a plurality of the temperature detection chips 11 is formed of a flexible conductor that can be drawn or bent in a desired direction. The temperature detection signal cable 13 has its conductor integrally formed with an insulating film 14. The insulating film 14 is a thin, narrow PET strip about 2 centimeters wide and has a two-layer structure made up of a base film 141 on the lower side and a cover film 142 on the upper side. The temperature detection signal cable 13 has silver strips 131 formed at predetermined intervals on the base film 141 (in a longitudinal direction along a widthwise center). At each of the intermittent gaps where the silver strip 131 is not present, the temperature detection chip 11 enclosed and protected by the pressure resisting member 12 is mounted. The silver strips 131 and the temperature detection chips 11 are connected through the lead terminals 111, 112, and the cover film 142 is laminated over them with an adhesive such as a hot melt 143.

The temperature sensor 1 therefore has a plurality of small temperature detection chips 11 protected by the pressure resisting member 12 and connected in series by the temperature detection signal cable 13. The temperature sensor 1 is laminated between layers of the insulating film 14 and shaped like a flexible, insulating ribbon or strip which is thin and lightweight. The temperature detection signal cable 13 of the temperature sensor 1 is connected with a temperature sensor cable 15 which in turn is connected to the temperature sensor unit 16, as shown in FIG. 4. The temperature sensor unit 16 is preferably installed independent of a control means that controls the floor heating system as a whole.

FIG. 4 shows a floor heating system using this temperature sensor 1. In FIG. 4, the floor heating system 4 includes a planar heater (heating film) 41, a floor heating controller 42, the temperature sensor 1, and the temperature sensor unit 16.

In the system 4, the planar heater 41 has carbon (carbon paste) strips 412 printed at predetermined intervals to a predetermined thickness on an insulating film sheet 411, such as PET, as a base material. The planar heater 41 also has flat cables (conductors) 413 on both (left and right) sides of the base material and a protective sheet 414 laminated over the carbon 412 and the flat cables 413. According to the control by the floor heating controller 42, an electricity is supplied to the flat cables 413 to cause current to flow through the carbon strips 412 for heating. At one part of the planar heater 41 on its back a thermistor 43 as a temperature sensor is installed. This thermistor 43 is connected to the temperature sensor unit 16 through a thermistor cable 431.

In this system 4, the temperature sensor 1 is laid over the planar heater 41 with the temperature detection chips 11 arranged at arbitrary scattered positions on the planar heater 41. In more detail, the temperature sensor 1 longitudinally extends over the planar heater 41, with the temperature detection chips 11 arranged on every other carbon strips 412 beginning with one end of the planar heater 41 so that a plurality of temperature detection chips 11 are finely distributed in a wide range of the planar heater 41. Because the temperature sensor 1 is formed like a ribbon, it can be cut to a desired length, linearly extended or bent for flexible wiring in a desired direction. Thus the temperature sensor 1 can be laid continuously over a plurality of planar heaters 41 allowing the temperature detection chips 11 to be installed at desired positions on each planar heater 41. In this temperature sensor 1, a temperature detection range can be set arbitrarily by changing the number of temperature detection chips 11 and their characteristics (resistance-temperature characteristics). In the event that an abnormal temperature rise occurs in a wide range, it can therefore be detected early at a lower temperature than a standard set temperature. After (or before) the temperature sensor 1 is mounted on the planar heater 41 in this manner, the temperature detection signal cable 13 is connected to the temperature sensor unit 16 through the temperature sensor cable 15. The temperature sensor unit 16 is controlled by the floor heating controller 42 to control the temperature sensor 1. The temperature sensor unit 16 supplies to the temperature sensor 1 a weak current that will not cause the temperature detection chips 11 to self-heat by the Joule effect. The temperature sensor unit 16 is provided independently of the floor heating controller 42 and thus functions as an emergency stop circuit for securing safety.

The temperature sensor 1 and the floor heating system 4 are controlled by the floor heating controller 42, which supplies a heating current to the planar heater 41 for heating to a predetermined temperature. The temperature sensor 1 (or temperature detection signal cable 13) is supplied a weak signal current from the temperature sensor unit 16 through the temperature sensor cable 15 to detect a temperature change in a wide range of the planar heater 41. While the planar heater 41 is uniformly kept at a predetermined temperature, the resistance of PTC device in each temperature detection chip 11 is small, allowing a signal current to flow through the temperature detection chips 11 and the temperature detection signal cable 13. This is a normal operating state of the temperature sensor 1. This normal state is recognized by the temperature sensor unit 16 and the floor heating controller 42 continues operation. If, however, the user uses the floor heating system 4 wrongly, as by putting an object on a part of the planar heater 41 to apply an external pressure to it, heat is trapped there causing an abnormal temperature rise. At this time, the temperature detection chip 11 located where the abnormal temperature rise has occurred is heated, increasing its resistance sharply to interrupt the signal current through the temperature detection chip 11. This abnormal state is immediately detected by the temperature sensor unit 16, prompting the floor heating controller 42 to stop the operation temporarily. After the operation is stopped, the temperature of the planar heater 41 falls and the temperature detection chip 11 returns to the normal state (by the self recovery of the PTC device). Then, the floor heating controller 42 resumes the operation by supplying the heating current to the planar heater 41 to heat it to a predetermined temperature. At the same time, the temperature sensor unit 16 supplies a signal current to the temperature sensor 1 to detect any temperature change in a wide range of the planar heater 41. This sequence of operation is repeated until the object, and therefore the pressure, is removed from the planar heater 41. In this way the planar heater 41 is temperature-controlled in its wide area.

As described above, the temperature sensor 1 has a plurality of flat temperature detection chips 11, each using the PTC device, enclosed by the pressure resisting member 12. The temperature detection chips 11 are connected in series by the temperature detection signal cable 13 (silver strips 131) and laminated between the layers of the insulating film 14 so that the temperature sensor 1 is formed like a flexible ribbon. The temperature detection chips 11 are located at desired scattered positions on the planar heater 41 and a signal current is applied to the temperature detection signal cable 13 to detect a temperature change in the planar heater 41. Thus, the temperature sensor 1 has a simple construction using the PTC devices and can efficiently detect a temperature in a wide range of the planar heater 41. This in turn provides the temperature sensor 1 with many advantages including improved durability, manufacturability and installability as well as reduced cost. Further, since the temperature detection chips 11 are supplied a weak signal current, not a heating current that is applied in the conventional sensors, the temperature detection chips 11 can be protected against deterioration, securing a self recovering ability of the PTC devices, keeping the PTC characteristic for a long period of time, and enhancing reliability of the temperature sensor 1.

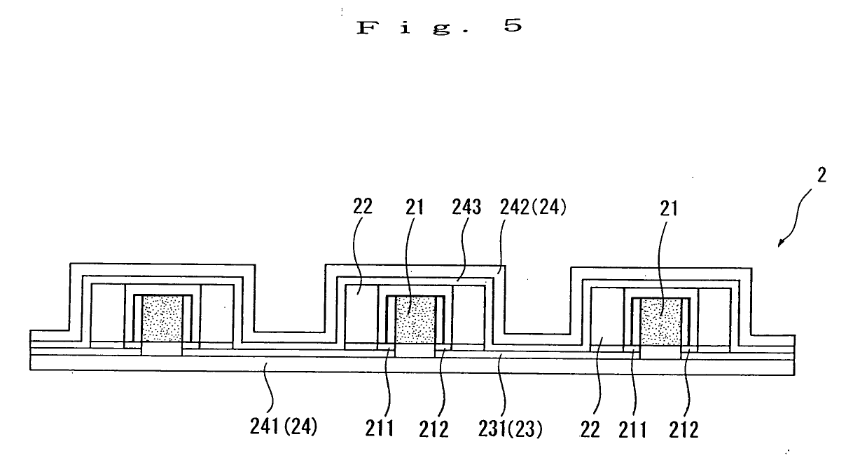

FIG. 5 and FIG. 6 illustrate a temperature sensor according to a second embodiment of this invention. As shown in FIG. 5 and FIG. 6, the temperature sensor 2 has the similar basic structure to that of the temperature sensor 1 of the first embodiment. That is, it includes a plurality of temperature detection chips 21, pressure resisting members 22 each protecting one temperature detection chip 21, and a temperature detection signal cable 23 connecting the temperature detection chips 21 in series. A plurality of the temperature detection chips 21 each protected by the pressure resisting member 22 are laminated between layers of an insulating film 24, together with the temperature detection signal cable 23. Overall, the temperature sensor 2 is formed like a ribbon. The individual temperature detection chips 21 are formed of a flat PTC device, with electrodes 211, 212 provided at its front and rear ends on the bottom surface. The temperature detection chips 21 may of course be formed into a rectangular or circular shape. The pressure resisting member 22 is a round spacer, circular in plan view, which encloses the temperature detection chip 21. The round spacer 22, as in the first embodiment, has its inner circumference set slightly larger than an outer circumference of the temperature detection chip 21 and its height set slightly larger than that of the temperature detection chip 21. The temperature detection signal cable 23 has its conductor integrally formed with the insulating film 24. The insulating film 24, as in the first embodiment, is a thin, narrow PET strip about 2 centimeters wide and has a two-layer structure made up of a base film 241 on the lower side and a cover film 242 on the upper side. The temperature detection signal cable 23 has silver strips 231 formed at predetermined intervals on the base film 241 (in a longitudinal direction along a widthwise center). At each of the intermittent gaps where the silver strip 231 is not present, the temperature detection chip 21 is mounted, with its electrodes 211, 212 connected with the silver strips 231. These are enclosed by the pressure resisting member 22 which is fixed with an adhesive. All these are covered from above with the cover film 242 through an adhesive such as a hot melt 243. This construction also produces the similar effect to that of the temperature sensor 1 of the first embodiment and thus can be applied to the floor heating system 4 in the similar manner for the same operation.

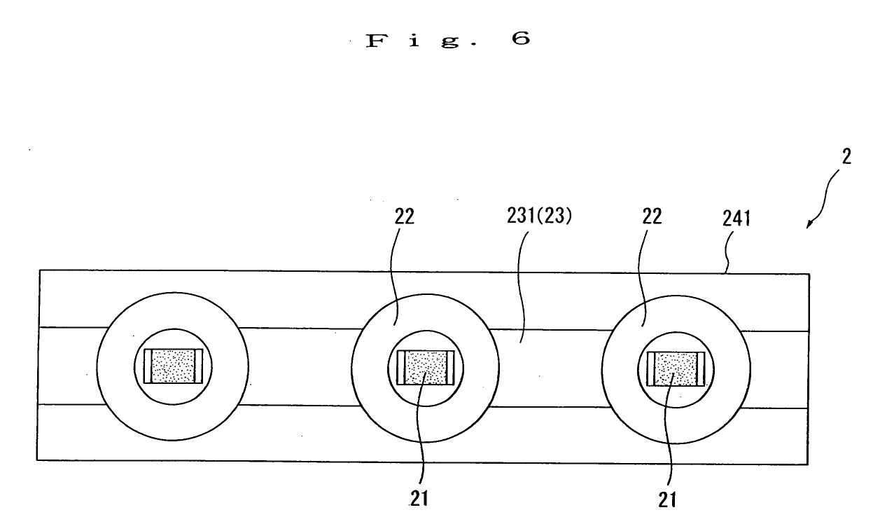

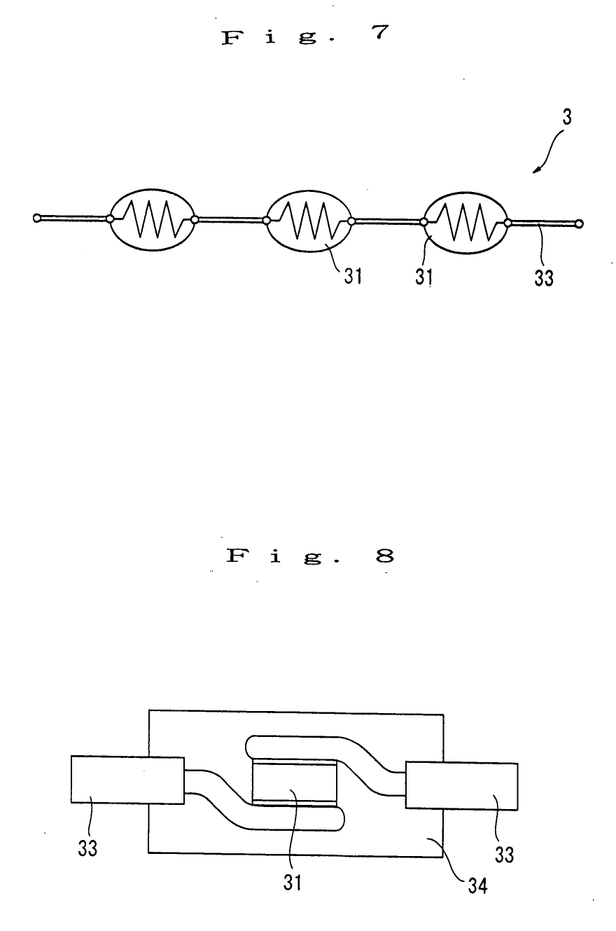

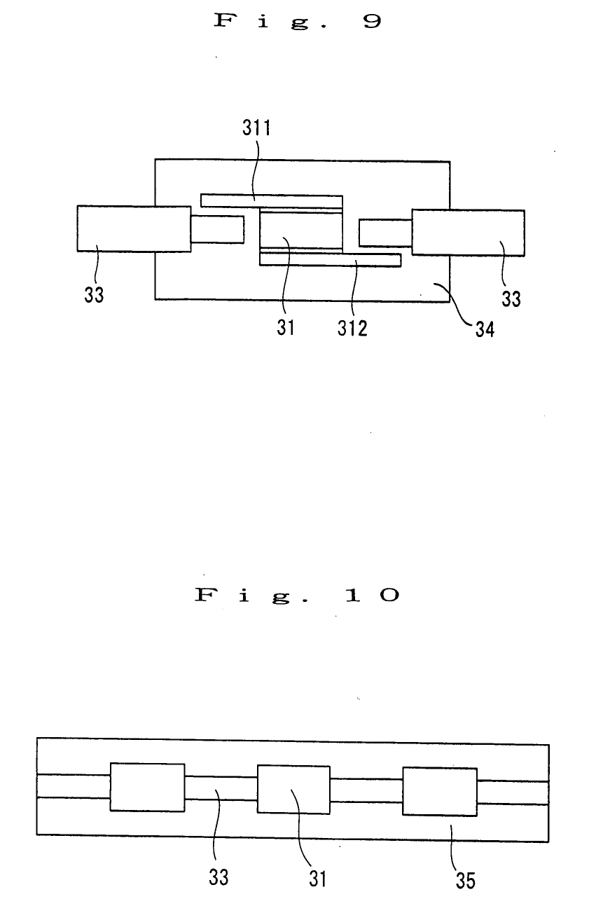

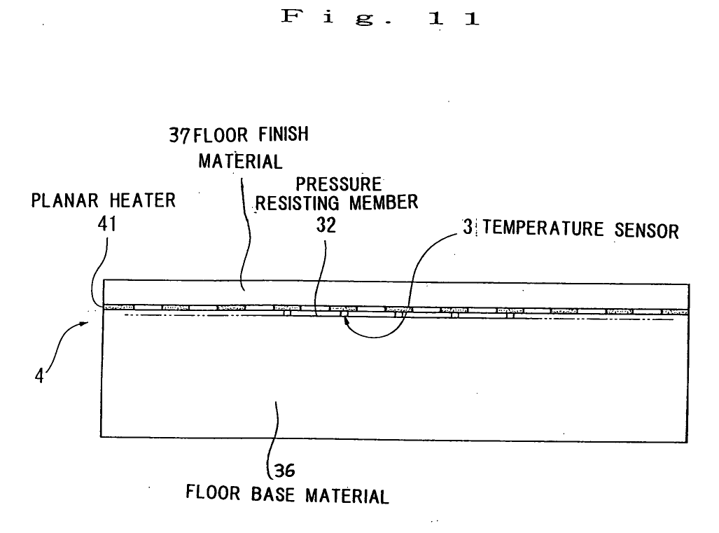

FIG. 7 to FIG. 11 illustrate a temperature sensor according to a third embodiment of this invention. In this embodiment, the temperature sensor 3 includes a plurality of temperature detection chips 31 and a temperature detection signal cable 33 connecting the temperature detection chips 31 in series, with each temperature detection chip 31 protected by a pressure resisting member 32 provided on the side of a floor base material 36 (see FIG. 11). The temperature detection chips 31 are made of a PTC device and formed flat. The temperature detection chips 31 connected with the temperature detection signal cable 33 are covered with an insulating protective member 34. The temperature detection signal cable 33 is soldered to the upper and lower surfaces of each temperature detection chip 31 through lead wires. The connection between the temperature detection chip 31 and the lead wires 33 may be made as shown in FIG. 8, in which the temperature detection chips 31 are each formed with a solder surface on the top and bottom surfaces thereof to which the lead wires are directly connected. The connection may also be made as shown in FIG. 9, in which the temperature detection chips 31 are each joined with lead terminals 311, 312 on the top and bottom surfaces thereof to which the lead wires 33 are connected. As shown in FIG. 10, a sheath 35 may be sleeved over the temperature detection chips 31 and the lead wires 33 to make them flat and smooth on their surface. As shown in FIG. 11, the pressure resisting member 32 is installed on a floor base material 36 on which the planar heater 41 is laid. The pressure resisting member 32 is formed with grooves of such a depth as can accommodate the temperature sensor 3 (particularly the temperature detection chips 31) resting on the floor base material 36 with the sensor top surface almost flush with that of the pressure resisting member 32. This construction can also produce the similar effect to those of the temperature sensors 1, 2 and be applied to the floor heating system 4 in the similar manner. Further, a floor top material (or floor finish material) 37 is laid on the planar heater 41, and a floor having heating function is completed as show in FIG. 11.

While in the above embodiments the floor heating system 4 using the temperature sensor 1, 2, 3 employs the planar heater 41 that is formed with strips of carbon 412, it is also possible to adopt a planar heater having the carbon 412 formed over its entire surface. In such a system, the temperature sensor 1, 2, 3 can also be used. Although the temperature sensor 1, 2, 3 has been shown to be a part of constitutional components of the floor heating system, it can also be applied as a single device to various heating systems, such as floor heating, wall heating and ceiling heating employing a variety of planar heaters.

While the preferred embodiments of the invention shown in the accompanying drawings have been described by way of example, it will be appreciated by those skilled in the art that changes and modifications may be made without departing from the spirit of the invention and that such changes are also included in the scope of the invention.

What is claimed is:

1. A temperature sensor comprising:
a plurality of temperature detection chips each formed flat and made of a device having a PTC (Positive Temperature Coefficient) characteristic, the temperature detection chips being adapted to detect a temperature change to turn on or off a current application;
pressure resisting members enclosing the individual temperature detection chips to protect them from external pressure; and
a temperature detection signal cable made of a flexible conductor, the flexible conductor being able to be extended or bent in a desired direction for wiring to connect the temperature detection chips in series;
wherein the temperature detection chips are located at arbitrary scattered positions on a planar heater and a signal current is applied to the temperature detection signal cable to detect a temperature change in the planar heater.

2. A temperature sensor according to claim 1, wherein the plurality of temperature detection chips are protected by pressure resisting members, laminated between layers of an insulating film along with the temperature detection signal cable and, as a whole, formed like a ribbon.

3. A temperature sensor according to claim 1, further including a means to control a current application to the temperature detection signal cable, the means being independent of a means for controlling the planar heater.

4. A heating system employing a variety of planar heaters and having the temperature sensor claimed in any one of claim 1 to claim 3.
